(19) United States
(12) Patent Application Publication
(10) Pub. No.: US 2011/0023065 A1
(43) Pub. Date: Jan. 27, 2011

(54) METHOD FOR PROVIDING A TELEVISION ELECTRONIC GUIDE

(76) Inventors: Peter Edlund, Ronninge (SE); Bo Aström, Stockholm (SE); Mats Cedervall, Harnosand (SE)

Correspondence Address: ERICSSON INC., 6300 LEGACY DRIVE, M/S EVR 1-C-11, PLANO, TX, 75024, US

(21) Appl. No.: 12/934,331

(22) PCT Filed: Mar. 26, 2008
(86) PCT No.: PCT/EP08/53536

§ 371 Date: Sep. 28, 2010

(51) Int. Cl. H04N 5/445

(52) U.S. Cl. 725/51

(57) ABSTRACT

A method and apparatus for providing a packet switched television guide such as an Electronic Program Guide or an Electronic Service Guide to a user. An Application Server receives and stores preferences relating to a packet switched television guide. When the Application Server subsequently receives a new or updated packet switched television guide from a packet switched television Guide Application Server, the Application Server filters elements of the packet switched television guide according to the preferences to remove information not relevant to a user associated with the preferences. The filtered packet switched television guide is then sent to the user. In this way, only relevant information is sent, which can reduce the bandwidth required in sending packet switched television guides, the frequency at which packet switched television guide updates need to be sent, and also the processing required by the user's receiving equipment in filtering out irrelevant information from the packet switched television guide.

### TECHNICAL FIELD

The present invention relates to the field of providing personalized packet switched TV Electronic Guides, and in particular to providing Electronic Programme and Electronic Service Guides.

### BACKGROUND

Television signals have historically been broadcast using radio wave analogue signals sent to a user's television receiving equipment. However, recent developments in Packet Switched (PS) networks and technologies now allow television signals to be provided over a fixed access or mobile access PS network. TV services broadcast over an Internet Protocol (IP) network are referred to as IPTV. IPTV is typically broadcast using a broadband access network, in which channels are transmitted over a broadband network from a super head-end down to an end-user's set top box (STB). Alternatively, TV services may be provided to a user's mobile telephone over a cellular network. This is termed Mobile TV (MTV).

IPTV and MTV can provide personalized, interactive media content to an end user that can also be adapted to take account of limitations of the equipment used to receive the television.

For the purposes of this discussion, such television will be termed packed switched TV, and this term is used herein to refer to IPTV provided over a fixed access network, MTV, or packet switched TV delivered over a packet switched network.

Packet switched TV services typically include an Electronic Service Guide (ESG) and an Electronic Programme Guide (EPG) that are provided to the receiving equipment, which is typically a Set Top Box (STB) or a mobile telephone. The EPG is an on-screen guide containing information that is relevant for the user's selection of TV services. This typically includes a programme guide detailing listings of which programmes are on which channels, and the EPG functionality allows the user to navigate, select, and discover content by time, title, channel, genre, etc. The EPG may also be linked to a Personal Video Recorder (PVR) in the network (N-PVR) or in a user's home premises, allowing a user to record programmes directly to a hard disk. The ESG contains information that is not visible to the user but is necessary for the receiving equipment to manage the services. This information is typically provided by the service provider and network operator, and may include information needed to access the media content, for example a PSI for Video on Demand content, a Temporary Mobile Group Identity (TMGI) or Multimedia Broadcast Multicast Service (MBMS)-specific data.

Over time, as television services, content and schedules change, the data associated with the ESG and the EPG changes. New data should be provided to the receiving equipment to ensure that the user is provided with the most up to date information,

The receiving equipment may support ESG and EPG updates by broadcast or unicast. An EPG Extensible Markup Language (XML) file is either pulled using a HTTP Request between the receiving equipment and an EPG server, or pushed using a Wireless Application Protocol (WAP) Push service. The receiving equipment should be able to determine the identification, version and validity of each ESG and EPG parameter. BOAST has, in OMA-TS-BCAST-V1_{—}0-20080226-C/Ch.5.5.2, defined methods for partial retrieval of the EPG.

The TISPAN/OPENIPTV Forum has proposed that an IP Multimedia Subsystem (IMS) Subscribe/Notify can be used to notify mobile and fixed terminal clients of changes to an EPG. By reception of Notify the receiving equipment invokes an HTTP request between the receiving equipment and the EPG server to retrieve the EPG. The EPG server downloads the latest version of the EPG associated with ESG.

To support users' particular interests, a TV application server stores user IPTV/MTV service profiles (herein referred to as packet switched TV Service Profiles), which are used to customize an individual user's TV experience. The packet switched TV service profile contains user profiles for Broadcast services, CoD services, nPVR services, IPTV terminal capability, etc.

The packet switched TV service profile is managed by the user invoking XML Configuration Access Protocol (XCAP) procedures between the receiving equipment and an XML Data Management Server (XDMS). XCAP allows a user to read, write and modify user specific data stored in XML format at the XDMS. The packet switched TV service profile stored by XDMS contains user specific service data to configure and manage packet switched TV services for that user. XCAP maps XML document sub trees and element attributes to HTTP URIs, so that these components can be directly accessed by HTTP. XCAP uses the HTTP methods PUT, GET, and DELETE to operate on XML documents stored in the server.

Each time that the EPG is updated, all users attached to the packet switched TV service are notified of the update via a Subscribe/Notify method, or alternatively the EPG update is pushed (WAP push service, SMS or other means such as a SIP Message). However, the EPG XML file is large and frequent updates of the EPG each time there is a change of EPG content places a large signalling load on down link channels in terms of SIP Notification messages and uplinks in terms of HTTP request PDUs. Each HTTP request generates additional downlink signalling load (HTTP answer) in terms of XML files, one for each user. Furthermore, the user experience can be affected by frequent updates, as unnecessary notifications of update can call for the user's attention and interrupt the channel being viewed by the user. Interruption can occur where, for example, the user's receiving equipment has the capability to perform one service at a time, or a reduced capacity when handling packets from different sources for different applications.

Similar problems arise for ESG updates, when for example the packet switched TV Application Server (AS) pushes ESG updates or sends a notification relevant to terminal capability. Such notifications are sent in the background and are invisible to the user. The notification can be filtered for relevant information by the receiving equipment, based on information on terminal capability such as screen size or pixel resolution,

### SUMMARY

The inventors have recognised the problems with the prior art methods of providing EPG and ESG updates to receiving equipment for receiving packet switched television such as IPTV and MTV. It is an object of the present invention to reduce the amount of signalling required to keep the EPG and ESG up to date in receiving equipment.

According to a first aspect of the invention, there is provided a method of providing a packet switched television guide to a user. The packet switched television guide is either an EPG or an ESG. An Application Server receives and stores preferences relating to a packet switched television guide. When the Application Server subsequently receives a new or updated packet switched television guide from a packet switched television Guide Application Server, the Application Server filters elements of the packet switched television guide according to the preferences to remove information not relevant to a user associated with the preferences. The filtered packet switched television guide is then sent to the user. In this way, only relevant information is sent, which can reduce the bandwidth required in sending packet switched television guides, the frequency at which packet switched television guide updates need to be sent, and also the processing required by the user's receiving equipment in filtering out irrelevant information from the packet switched television guide. The packet switched television guide is optionally a fixed access IPTV guide or a Mobile TV guide.

As an option, the packet switched television guide is selected from one of an Electronic Programme Guide and an Electronic Service Guide. The preferences include information selected from capabilities of user receiving equipment, which may be obtained automatically when the receiving equipment attaches to the network; preferences input by the user, which may include restricting updates for content in which the user has no interest; and preferences determined by the user's historical IPTV viewing habits, which may be inferred by the receiving equipment. Where the preferences include information about the capabilities of the user's receiving equipment, these may be statically provisioned per user or more commonly reported by the user's receiving equipment as part of a service attachment or discovery procedure. It is unlikely that the user will manage the capabilities of the receiving equipment. This information is typically used to filter an Electronic Service Guide, but may also be relevant to filtering of an Electronic Programme Guide.

The Application Server is optionally selected from one of a Mobile TV Application Server and an IPTV Application Server, depending on the network environment.

The filtered packet switched television guide is optionally sent to one of a Set Top Box, a mobile terminal and a personal computer, although it may be sent to any suitable receiving equipment.

As an option, the preferences are expressible in an Extensible Markup Language (XML) format. They may be stored internally at the Application Server in a different format, but in this embodiment should be exportable in an XML format.

According to a second aspect of the invention, there is provided an Application Server for use in a packet switched television network. The Application Server is provided with a first receiver for receiving user preferences relating to a packet switched television guide. A memory is provided for storing the user preferences at the Application Server. A second receiver is provided for receiving from a packet switched television Guide Application Server a packet switched television IPTV guide, and a processor is provided for filtering elements of the received packet switched television guide according to the preferences. This removes information not relevant to a user associated with the preferences. A transmitter is also provided to transmit the filtered packet switched television guide to the user. The filtered packet switched television guide requires less bandwidth to send than the unfiltered packet switched television guide, and may reduce processing power required at the user's receiving equipment that would otherwise be required to filter the packet switched television guide.

As an option, the packet switched television guide is selected from one of an Electronic Programme Guide and an Electronic Service Guide. The preferences optionally include information selected from capabilities of user receiving equipment, preferences input by the user, and preferences determined by the user's historical packet switched television viewing habits. The Application Server is optionally selected from one of a Mobile TV Application Server and an IPTV Application Server.

According to a third aspect of the invention, there is provided receiving equipment for receiving packet switched television channels over a communications network. The receiving equipment is provided with a transmitter for sending to an Application Server preferences relating to selected packet switched television guide information for subsequent storage at the Application Server. The Application Server can then use the preferences to filter packet switched television guides for subsequent sending to the receiving equipment. As an option, the preferences are selected from capabilities of the receiving equipment, preferences input by a user, and preferences determined by the user's historical packet switched television viewing habits.

### BRIEF DESCRIPTION OF THE DRAWINGS

FIG. 1 illustrates schematically in a block diagram a system architecture according to an embodiment of the invention;

FIG. 2 is a flow diagram showing steps according to an embodiment of the invention;

FIG. 3 illustrates schematically in a block diagram an Application Server according to an embodiment of the invention;

FIG. 4 illustrates schematically in a block diagram receiving equipment according to an embodiment of the invention; and

FIG. 5 is a signalling diagram illustrating signalling in a Mobile TV network according to an embodiment of the invention.

### DETAILED DESCRIPTION

The following description sets forth specific details, such as particular embodiments, procedures, techniques, etc. for purposes of explanation and not limitation. In some instances, detailed descriptions of well known methods, interfaces, circuits, and devices are omitted so as not obscure the description with unnecessary detail. Moreover, individual blocks are shown in some of the drawings. It will be appreciated that the functions of those blocks may be implemented using individual hardware circuits, using software programs and data, in conjunction with a suitably programmed digital microprocessor or general purpose computer, using application specific integrated circuitry, and/or using one or more digital signal processors.

The invention provides a user profile that is stored at an Application Server (AS) disposed in the network. The AS has an XML Configuration Access Protocol (XCAP) interface with a client over which the user can configure and modify information in their profile that is relevant to IPTV. The user can configure his profile in terms of EPG updates. When an EPG (or ESG) changes, the AS sends to the user only those changes relevant to the user as defined in the user profile. This reduces unwanted signalling of sending all EPG and ESG updates to each user.

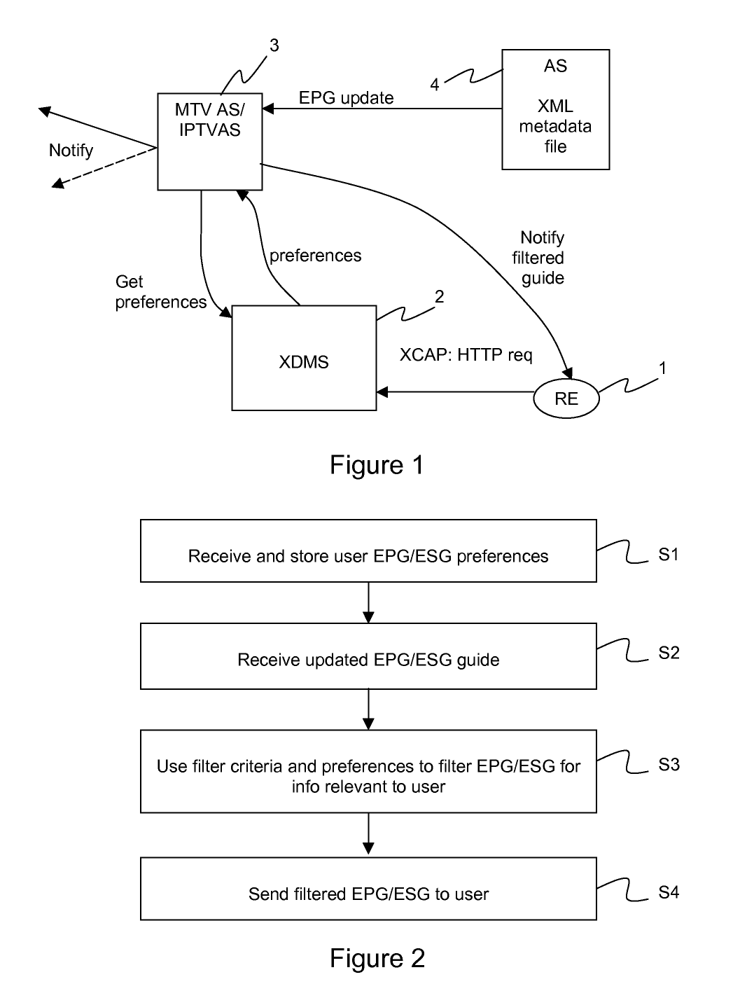

Referring to FIG. 1 herein, there is illustrated a user's receiving equipment 1. The receiving equipment may be any equipment suitable for receiving IPTV, but in a fixed access network is likely to be a Set Top Box (STB), and in a mobile network, is likely to be a mobile terminal. However, any other receiving equipment may be used, for example a personal computer receiving IPTV over a broadband connection.

Using the XCAP interface between the receiving equipment and an XDMS 2, the user can perform Subscriber Service Management to configure an EPG preference profile specific to the user. This might include, for example, requesting that pay-per-view channels are not included in the user's EPG, or that updates relating to sporting events are highlighted to the user. The user preferences may also be inferred from historical user behaviour. For example, a user may historically have never viewed sporting media content, and so the user preferences could be set to take account of the fact that the user is unlikely to require EPG updates for media channels showing sporting content. Preferences set by the user may be stored separately from preferences inferred from the user's historical behaviour, as different filter rules may apply depending on whether the preferences have been set or inferred. The EPG preference profile can be a new XML element introduced in the user's IPTV service profile to receive customized notifications of EPG updates. The user profile may also include terminal capabilities that might affect which updates are sent to the user. The attached appendix shows a typical XML schema for a user profile.

The AS 3 obtains and stores the user profile containing the user's EPG preferences. Each time an update to an EPG occurs, an EPG AS 4 updates the metadata file for the EPG service and sends the updated EPG to the AS 3. The updated EPG includes information such as IPTV channel id, IPTV channel description, IPTV channel provider, TV program id, Time, Unicast/broadcast, Video and audio codec used, End-to-end transport, Audio Language, Text language, programme category, Temporary Mobile Group Identity (TMGI), Service Area Identification (SAI), Audio/Video, Multimedia Broadcast Multicast Service (MBMS)/Digital Video Broadcasting Handheld (DVB-H)/Wifi, IP Multi-cast Address (IPMC).

The AS 3 is provided with an evaluation criteria function that evaluates and filters the EPG update sent by the IPTV EPG AS according to the user EPG preference, which may also include the user receiving equipment capabilities. The user receiving equipment capabilities may be either configured statically in the IPTV XDMS or received as part of Service Attachment/Discovery procedures, and those parts of the updated EPG to the receiving equipment 1 accordingly. Note that a user may receive IPTV over more than one type of equipment. For example, a user's preference profile may indicate that the user sometimes views IPTV content at home using a STB, and sometimes views IPTV content using a mobile terminal. The STB and the mobile terminal may well have different capabilities, and so the EPG update sent to the mobile terminal may differ from the EPG update sent to STB.

In this way, only updates relevant to each user are sent, which minimizes signalling requirements and processing requirements at the receiving equipment 1, which would otherwise need to filter out irrelevant aspects of the EPG update.

In order to illustrate the invention, FIG. 2 shows the basic steps according to an embodiment of the invention. The following numbering corresponds to the numbering in FIG. 2:

S1. The AS 3 requests and receives EPG or ESG preferences from a user, and stores the received preferences.
S2. When an EPG or ESG is updated, it is sent to the AS 3 from an EPG AS 4.
S3. The AS 3 compares the received EPG or ESG with filter criteria based on the user preferences, and filters irrelevant information out of the EPG.
S4. The AS 3 sends the filtered EPG or ESG to the user's receiving equipment 1.

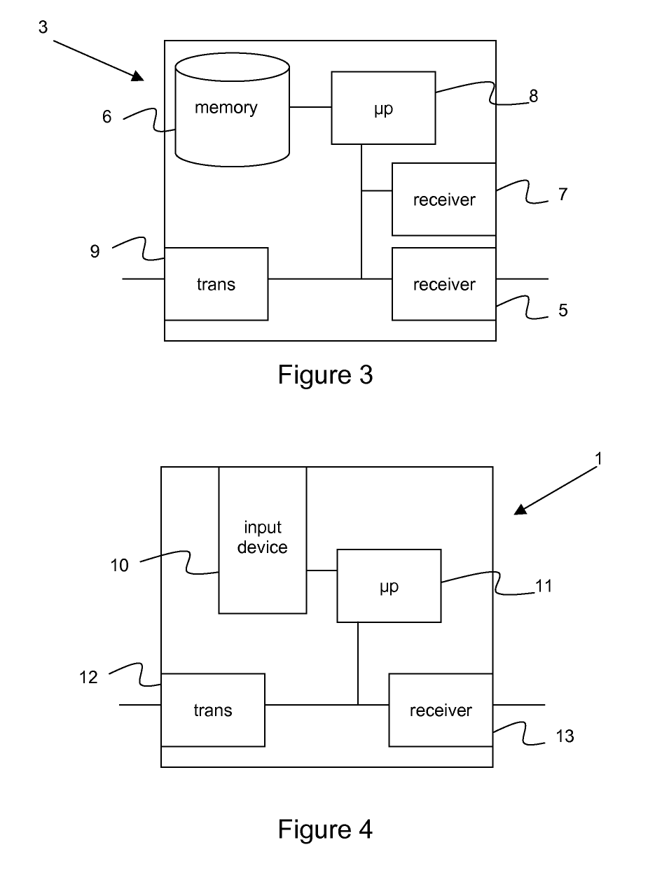

Referring now to FIG. 3, there is illustrated an AS 32 according to an embodiment of the invention. The AS 3 is provided with a first receiver 5 for receiving user preferences from a user, and a memory 6 for storing the received preferences. A second receiver 7 is provided for receiving an updated or new EPG or ESG from an EPG AS 43. A processor 8 filters the received EPG/ESG according to the stored user preferences, and a transmitter 9 is provided for sending the filtered EPG/ESG to the user's receiving equipment 1. The AS may be any suitable AS, such as a Mobile TV As and an IPTV AS.

Referring to FIG. 4, there is illustrated receiving equipment 1 according to an embodiment of the invention. The receiving equipment 1 may be provided with an input device 10 allowing a user to set their preferences. A processor 11 is provided for generating a message relating to EPG or ESG user preferences. These preferences can be based on the input preferences, the receiving equipment 1 capabilities and the user's historical viewing behaviour. A transmitter 12 is provided to sending the message to an Application Server 3. A receiver 13 is also provided for receiving from the AS 3 an EPG or ESG filtered according to the user preferences.

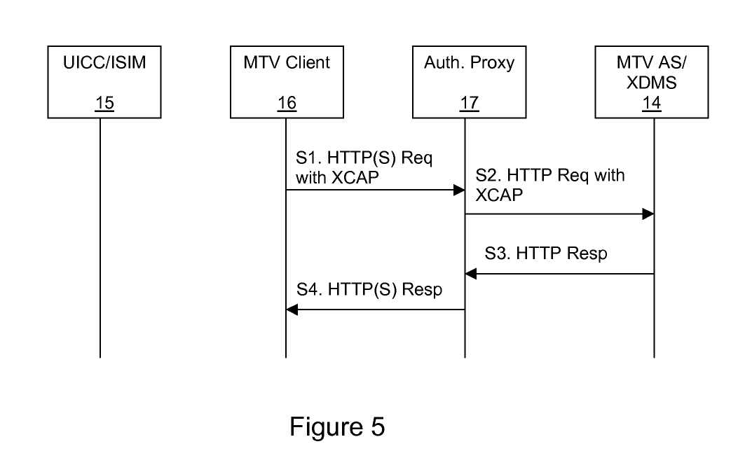

By way of example, and to describe how the invention works in a Mobile TV network, FIG. 5 illustrates signalling between nodes. As described above, the user profile is configured for EPG updates (prf_epg_upd). The EPG filtering mechanism implemented in the MTV AS 14 takes into consideration terminal 15 capability (ua-Prof either configured statically in the IPTV XDMS or received as part of Service Attachment/Discovery procedures) and prof_epg_upd. For example, if a change to an EPG occurs for a sports event shown on an HDTV channel and a user wishes to receive Notifications for “EPG-Sport-changes”, it is not necessary to send a Notify if the terminal 15 currently used does not have HDTV capabilities. The MTV client 16 in the terminal 15 may send updates to the user preferences securely via an Authorization Proxy node 17, which will in turn update the MTV AS 14.

The invention allows EPG/ESG preferences to be set and EPG/ESGs to be filtered for relevant information before sending them to each user each time the EPG/ESG is updated. This reduces signalling load and payload in the access network. Furthermore, it avoids the sending of unnecessary and unwanted notifications of EPG/ESG updates that will not be retrieved by the user. Less complex processing is required in the receiving equipment, as the receiving equipment does not need to filter the updates for unnecessary information.

Although various embodiments have been shown and described in detail, the claims are not limited to any particular embodiment or example. None of the above description should be read as implying that any particular element, step, or function is essential such that it must be included in the claims' scope. The scope of protection is defined by the claims.

The following abbreviations are used in this specification:

CoD Content on Demand

EPG Electronic Program Guide

ESG Electronic Service Guide

HTTP Hypertext Transfer Protocol

IPTV Internet Protocol Television

MTV Mobile TV

prf_epg_upd preferred EPG Update

nPVR Network based Personal Video Recorders

STB Set Top Box

ua-Prof Terminal capability

URI Uniform Resource Identifier

XCAP XML Configuration Access Protocol.

XDMS XML Data Management Server

APPENDIX
XML Schema for the IPTV profile

<?xml version=″1.0″ encoding=″UTF-8″?>
<xs:schema
xmlns:xs=″http://www.w3.org/2001/XMLSchema″
elementFormDefault=″qualified″
attributeFormDefault=″unqualified″>
<xs:element name=″IPTVProfile″>

<xs:annotation>

<xs:documentation> XML Schema for representing the IPTV Profile

object identified in TS 182 027 clause 7.3.1

</xs:documentation>

```
  </xs:annotation>
  <xs:complexType>
```

<xs:sequence>

<xs:element name=″UEProfile″ type=″tUEProfile″ minOccurs=″0″/>
<xs:element name=″GlobalSettings″ type=″tGlobalSettings″

minOccurs=″1″/>

<xs:element name=″BCProfile″ type=″tBCProfile″ minOccurs=″0″/>
<xs:element name=″CoDProfile″ type=″tCoDProfile″ minOccurs=″0″/>
<xs:element name=″PVRProfile″ type=″tPVRProfile″ minOccurs=″0″/>
<xs:element name=″Extension″ type=″tExtension″ minOccurs=″0″/>
<xs:any namespace=”##other” processContents=″lax″ minOccurs=″0″
<xs:element name= =″UserPrefEPG″ minOccurs=”0”

maxOccurs=″unbounded″/>

</xs:sequence>
<xs:attribute name=″ProfileId″ type=″xs:ID″ />
<xs:anyAttribute/>

</xs:complexType>

</xs:element>

<xs:complexType name=″tBCProfile″>

<xs:sequence>

<xs:element name=″BCServicePackage″ type=″tBCServicePackage″

minOccurs=″1″

maxOccurs=″unbounded″/>

<xs:any namespace=″##other″ processContents=″lax″ minOccurs=″0″

maxOccurs=″unbounded″/>

</xs:sequence>

</xs:complexType>
<xs:complexType name=″tUEProfile″>

<xs:sequence>

<xs:element name=″UserEquipmentID″ type=″tUEID″ minOccurs=″1″/>
<xs:element name=″UECapabilities″ type=″tUECapabilities″

minOccurs=″0″/>

<xs:element name=″PrfEPGupd″> type=″tPrefEPGupd″ minOccurs=″0″/>
<xs:element name=″Extension″ type=″tExtension″ minOccurs=″0″/>
<xs:any namespace=″##other″ processContents=″lax″ minOccurs=″0″

maxOccurs=″unbounded″/>

</xs:sequence>

</xs:complexType>
<xs:simpleType name=″tUEID″ final=″list restriction″>

<xs:restriction base=″xs:string″>

<xs:minLength value=″0″/>
<xs:maxLength value=″16″/>

</xs:restriction>

</xs:simpleType>
<xs:complexType name=″tUECapabilities″>

<xs:sequence>

<xs:element name=″UserEquipmentClass″ type=″tUserEquipmentClass″

minOccurs=″1″/>

<xs:element name=″Resolution″ type=″tResolution″ minOccurs=″0″/>
<xs:element name=″SupportedEncodings″ type=″tSupportedEncodings”″

minOccurs=″0″ maxOccurs=″unbounded″/>

<xs:element name=″IPEncapsulations″ type=″tIPEncapsulations″

minOccurs=″0″ maxOccurs=″unbounded″/>

<xs:element name=″Extension″ type=″tExtension″ minOccurs=″0″/>
<xs:any namespace=″##other″ processContents=″lax″ minOccurs=″0″

maxOccurs=″unbounded″/>

</xs:sequence>

</xs:complexType>

<xs:complexType name=″tPrefEPGupd″>

<xs:sequence>

<xs:element name=″UserPrefEPG″ type=″tUserPrefEPG″ minOccurs=″1″/>

</xs:sequence>

</xs:complexType>
<xs:element name=″PrefChannel″=tPrefChannel

minoccurs=″0″ maxOccurs=″unbounded″

<xs:element name=″Category″=tCategory

minoccurs=″0″ maxOccurs=″unbounded″

<xs:element name=″ContentProvider″=tContentprovider

minoccurs=″0″ maxOccurs=″unbounded″

<xs:element name=″StartingTime″=tStartingTime

<xs:simpleType name=″tUserEquipmentClass″ final=″list restriction″>

<xs:restriction base=″xs:string″>

<xs:minLength value=″0″/>
<xs:maxLength value=″16″/>

</xs:restriction>

</xs:simpleType>
<xs:simpleType name=″tResolution″ final=″list restriction″>
<xs:annotation>

<xs:documentation>
<label xml:lang=″en″>resolution</label>
<definition xml:lang=″en″>Specifies the UE resolution support-eg. HD,SD

or LD</definition>

</xs:documentation>
</xs:annotation>

<xs:restriction base=″xs:string″>

<xs:enumeration value=″HD″>
</xs:enumeration>
<xs:enumeration value=″SD″>
</xs:enumeration>
<xs:enumeration value=″LD″>
</xs:enumeration>

</xs:restriction>

</xs:simpleType>

1. A method of providing a packet switched television guide to a user, the method providing:
at an Application Server, receiving and storing preferences relating to a packet switched television guide;
receiving from a packet switched television guide Application Server the packet switched television guide;
filtering elements of the packet switched television guide according to the preferences to remove information not relevant to a user associated with the preferences; and
sending the filtered packet switched television guide to the user.

2. The method according to claim 1, wherein the packet switched television guide is selected from one of a fixed access Internet Protocol Television guide and a Mobile Television guide.

3. The method according to claim 1 or 2, wherein the packet switched television guide is selected from one of an Electronic Programme Guide and an Electronic Service Guide.

4. The method according to claim 1, 2 or 3, wherein the preferences include information selected from capabilities of user receiving equipment, preferences input by the user, and preferences determined by the user's historical packet switched television viewing habits.

5. The method according to any one of claims 1 to 4, wherein the Application Server is selected from one of a Mobile TV Application Server and an IPTV Application Server.

6. The method according to any one of claims 1 to 5, comprising sending the filtered packet switched television guide to one of a Set Top Box, a mobile terminal and a personal computer.

7. The method according to any one of claims 1 to 6, comprising storing the preferences expressible in an Extensible Markup Language format.

8. An Application Server for use in a packet switched television network, the Application Server comprising:
a first receiver for receiving preferences relating to a packet switched television guide;
a memory for storing the preferences;
a second receiver for receiving from a packet switched television Guide Application Server the packet switched television guide;
a processor for filtering elements of the received packet switched television guide according to the preferences to remove information not relevant to a user associated with the preferences; and
a transmitter for sending to the user the filtered packet switched television guide.

9. The Application Server according to claim 8, wherein the packet switched television guide is selected from one of an Electronic Programme Guide and an Electronic Service Guide.

10. The Application Server according to claim 8 or 9, wherein the preferences include information selected from capabilities of user receiving equipment, preferences input by the user, and preferences determined by the user's historical packet switched television viewing habits.

11. The Application Server according to any one of claim 8, 9 or 10, wherein the Application Server is selected from one of a Mobile TV Application Server and an IPTV Application Server.

12. Receiving equipment for receiving packet switched television channels over a communications network, the receiving equipment comprising a transmitter for sending to an Application Server preferences relating to selected packet switched television guide information.

13. Receiving equipment according to claim 12 wherein the preferences are selected from capabilities of the receiving equipment, preferences input by a user, and preferences determined by the user's historical packet switched television viewing habits.
